(19) United States
(12) Patent Application Publication
(10) Pub. No.: US 2004/0112685 A1
(43) Pub. Date: Jun. 17, 2004

(54) Bicycle cable brake control line

(76) Inventor: Christopher A. Cotsonas, Cerritos, CA (US)

Correspondence Address: Charles H. Thomas, CISLO & THOMAS LLP, Suite 405, 4201 Long Beach Blvd., Long Beach, CA, 90807-2022, US

(21) Appl. No.: 10/318,553

(22) Filed: Dec. 13, 2002

(51) Int. Cl. B60T 1/00

(52) U.S. Cl. 188/2 D

(57) ABSTRACT

A single rear bicycle brake control cable core is employed to operate the rear brake of a freestyle bicycle that employs a rotatable coupling that allows the handlebars, front wheel, and front wheel fork of a bicycle to be rotated through a complete revolution about the axis of the head tube of the bicycle frame. The single brake control cable core is looped about a roller which may be a pulley attached to the cable-engaging end of the handlebar-mounted rear brake lever, so that the point of contact between the control cable loop relative to the brake lever is not fixed. Cable sheaths surround portions of the cable core and are seated in a cable segment connector that in turn is rotatably mounted in a cable coupler attached to a handlebar-mounted brake lever assembly body. The coupler rotates about its own axis to maintain the unsheathed, proximal portions of the loop adjacent the pulley in coplanar alignment with the pulley. The brake lever rotates relative to the brake lever assembly body so as to move the pulley closer to or further from the cable coupler. Because the control cable loop passes about the pulley, tension on the cable brake line allows the gyroscopic system to self-adjust the balance of its bearing unit. Preferably, a toggle link is provided between the cable-engaging end of the brake lever and the cable core loop. The pulley is mounted at the end of the toggle link, remote from the brake lever.

### BACKGROUND OF THE INVENTION

1. Field of the Invention

The present invention relates to a bicycle brake cable system operated by a brake control lever mounted on a bicycle handlebar in a bicycle in which the handlebars and front wheel of the bicycle are freely rotatable relative to the bicycle frame.

2. Description of the Prior Art

A conventional bicycle employs a frame upon which the seat, rear wheel, pedals, and chain drive transmission mechanism are mounted, and a steering assembly that can be turned relative to the frame. The major components of a bicycle steering assembly include a front wheel, a front wheel fork, a steering tube, a handlebar stem, and a set of handlebars. The steering assembly can be turned at an angle relative to the frame about an axis of rotation extending along the center of the steering tube of the steering assembly, which is also the center of the head tube of the frame. The steering tube is mounting coaxially within the head tube and turns relative thereto on steering bearings interposed therebetween.

A number of years ago rotatable brake cable coupling systems were devised for use on a bicycle which allowed a rider to completely rotate the steering assembly of a bicycle as a unit relative to the bicycle frame on a bicycle having hand brakes. Prior to this time such a manipulation was not possible since the bicycle brake cables extending from the hand brake controls on the handlebars to the brake calipers of the brakes on the front and rear wheels of a bicycle would permit only limited rotation of the steering assembly relative to the frame to an arc of far less than 360 degrees.

However, a rotatable brake cable coupling system allows the front wheel, front wheel fork, steering tube, and handlebars of a bicycle to be rotated together through repeated 360-degree revolutions relative to the bicycle head tube and bicycle frame. This feature allows riders to perform stunts while only the rear wheel of the bicycle is in contact with the riding surface or while only the front wheel is in contact with the riding surface. A bicycle having this capability is known in the bicycle industry as a “free-style” bicycle and the rotatable coupling is often referred to as a cable “detangler”.

One embodiment of a rotatable brake cable coupling system is described in Patent No. 084,322 issued in the Republic of China (Taiwan). Such a rotatable brake coupling system is sold commercially as the Gyro rotatable brake coupling system by Bear Corporation located at 16325 Arthur Street, Cerritos, Calif. 90703.

In a conventional rotatable brake cable coupling system the rear brake cable is divided into two segments, namely a lower operating segment and an upper control segment. The lower operating segment has a single brake operating end termination and a pair of control coupling end terminations. The single brake operating end termination is secured to the rear brake. Specifically, the cable sheath is secured to one of the brake calipers and the cable core that moves in reciprocation within the sheath extends onto and is terminated at the other brake caliper.

The pair of control coupling end terminations extend from a junction on the frame and up the outside of the head tube at the front of the frame to a lower cable stop. The lower cable stop is formed with a pair of diametrically opposed brake cable termination ears that are fixed relative to the bicycle frame head tube and rotatable relative to the front wheel assembly. The cable sheaths of the control coupling end terminations of the lower, operating segment of the rear brake cable are secured to the bicycle head tube by means of connections to the brake cable termination ears while the control coupling end terminations of the rear brake cable operating segment core elements extend upwardly from the sheath terminations and are connected to the portion of an annular rotor that is nonrotatable relative to the head tube and rotatable relative to the front wheel steering assembly.

The upper or control segment of the rear brake cable likewise has a single brake control end termination that is connected to a rear hand brake control mounted on one of the handlebars of the bicycle. The upper, control segment of the rear brake cable extends downwardly from the handlebars and terminates in a pair of operating end coupling terminations. The control segment sheath elements of the upper or control segment of the rear brake cable are fastened to a pair of diametrically opposed upper brake cable termination ears that are secured to the steering tube of the bicycle. The core member components of the upper, control segment of the rear brake cable extend downwardly past the terminations of the sheath members in which they are disposed and are secured to the portion of the brake cable coupling system rotor that is nonrotatable relative to the front wheel steering assembly and rotatable relative to the bicycle frame.

In the brake cable coupling system rotor there are components which are rotatable relative to each other. To distinguish these components from each other the portion which is constrained from rotation relative to the front wheel steering assembly is hereinafter referred to as “rotatable”, while the portion that is constrained from rotation relative to the bicycle head tube and the bicycle frame is referred to as “nonrotatable”.

The rotor coupling includes a bearing race between its nonrotatable and rotatable portions in which a number of ball bearings are arranged in an annular ring about the head tube of the bicycle frame. The rotatable portion of the rotor turns in rotation with the steering tube but can move in longitudinal reciprocation relative thereto. The rotatable portion of the rotor is carried in rotation with the steering tube by virtue of the connection of the cable sheath operating end coupling terminations of the upper cable control segment to the upper brake cable termination ears and by the connection of the core elements of the cable control segment to the rotatable portion of the rotor. The control coupling end terminations of the operating segment are prevented from rotating relative to the head tube by virtue of the connection of the sheath elements thereof to the lower fixed brake cable termination ears and the connection of the core elements thereof to the nonrotatable rotor portion. However, the nonrotatable portion of the rotor can move in longitudinal reciprocation relative to the head tube.

The operation of the hand brake lever mounted on the bicycle handlebar that controls the rear wheel brake places tension on the inextensible core elements of the cable control segment of the rear brake cable. This draws both the rotatable and nonrotatable portions of the rotor upwardly toward the handlebars in longitudinal movement relative to both the steering tube and the head tube. Since the nonrotatable portion of the rotor is coupled to the rotatable portion thereof through the overhanging arrangement of the bearing races, the entire rotor assembly is drawn upwardly. This transmits the tensile force from the core elements of the upper, cable control segment of the rear brake cable to the core elements of the lower, operating segment of the rear brake cable. This tensile force in turn operates the calipers of the rear brake.

Prior brake cable systems of this type have certain disadvantages. Specifically, the cable couplings of the dual cables on either side of both the rotatable and nonrotatable portions of the rotor must be independently adjustable and must be closely balanced relative to each other. If they are not, the rotor assembly will tilt out of perpendicular alignment relative to the stem of the bicycle fork when the brakes are applied. This is known as cable “flop”.

One device which has the effect of approaching a solution to this problem is the upper brake control line employed on the Mongoose “Wildcard” model bicycle, manufactured by Pacific Cycle USA, located at 4311 Triangle Street, McFarland, Wis. 53558-0230. In this system the upper brake cable control segment has a single, inextensible inner core formed into a loop and passed about a pulley located at the brake lever assembly. The terminal ends of the loop are attached to the rotatable portion of the cable detangler. By exerting tension on the loop where it passes about the pulley, there is some self-adjustment, since the inextensible core has a floating point of contact with the roller so that force on the distal ends of the core tend to pull with equal force on the opposing sides of the cable detangler. However, twisting of the handlebars relative to the bicycle frame during steering of the bicycle, and even bends in routing of the portions of the cable loop from the brake lever assembly to the cable detangler cause the portions of the inextensible core on the opposing sides of the pulley to be pulled out of coplanar alignment with the pulley. This interferes with the equalization of forces applied to the distal end terminations of the core at the cable detangler.

### SUMMARY OF THE INVENTION

According to the present invention, the upper, control segment of a bicycle brake cable system employs a single brake cable core rather than a pair of cable core portions. The single rear brake control cable core is formed into a loop and has opposing ends which are both terminated at the rotatable portion of the rotatable coupling of a cable detangler. The single control brake cable core is terminated at one end extremity to one side of the upper annular rotor coupling plate and from there extends through a section of cable sheath. After emerging from that section of the cable sheath the single control brake cable core is turned 180° about a roller which may be a turning pulley that is coupled to the brake control lever. After this turn the cable core is directed through another section of cable sheath. The other end extremity of the control cable core is coupled to the opposing side of the annular upper rotor coupling plate. Since there is a single brake cable control line passing through a floating roller point of contact, the system is self balancing.

To prevent proximal, unsheathed portions of the single brake cable core loop from being pulled out of coplanar relationship with each other and out of alignment with the roller, the brake lever assembly body is equipped with a cable segment connector at the point of entry of the cable core loop into the brake lever assembly body and also with a coupler mounted at that location for rotation relative to the cable segment connector. The proximal ends of the two cable sheath sections are seated in the coupler, side-by-side. The proximal, unsheathed portions of the cable core loop extend from the two sheath sections and longitudinally through the surrounding cable segment connector in a force application direction, that is toward the roller and toward the brake lever. Consequently, despite twisting of the bicycle handlebars and bends in the routing of the cable toward the detangler mechanism, the proximal, unsheathed portions of the cable core loop residing on the opposing sides of the roller remain in mutually coplanar relationship, and in coplanar relationship with the roller. This is possible due to the rotational movement of the coupler within the cable segment connector.

A coupling link is preferably connected between the turning pulley and the brake lever handle. The pulley is mounted on the coupling link rather than directly on the brake lever. Thus, the turning pulley rotates so that equal tension is exerted along the two portions of the control brake cable core, thereby balancing the lifting forces applied to the annular, upper rotor coupling plate. The tension on the opposing ends of the single upper cable core segment causes the pulley to rotate so as to equalize force transmitted to both sides of the rotatable coupling.

A single brake cable core operating loop is preferably also employed below the “gyro” rotor coupler. Instead of being terminated at one of the brake calipers, this single, inextensible lower cable core operating loop is looped about rollers in the form of pulleys attached to both of the brake calipers. The pulley attachments at the rear brake lever arms allow the operating segment of the lower brake cable also to be set up with a single length of cable core rather than the conventional “two-in-one” or two cable configuration. The brake cable core of the operating segment of the brake cable is secured at both of its ends to the annular lower coupling plate. Since there is a single brake cable core line passing through floating roller points, the system is self-balancing. The contact points on the operating cable core loop with the brake calipers are not fixed.

The floating force application pulleys of both the upper and lower cables thereby equalize tension applied to the ends of both the rear brake cable core segments, which are coupled to opposing sides of their respective coupling plates. The equalization of forces on the coupling plates keeps them from “flopping”. Thus, tension on the cable line allows the gyroscopic system to self-adjust and equalize longitudinal forces on both sides of the rotor coupling. This design decreases common rotational “flop” when turning the handlebars that is caused by poorly tensional conventional “fixed” cable set-ups.

In one broad aspect the present invention may be considered to be a bicycle brake cable system for operating a pair of opposing bicycle brake calipers from a handlebar-mounted brake lever assembly and including a rotatable coupling enabling free spinning of a bicycle handlebar and front wheel assembly relative to an associated bicycle frame. The bicycle brake cable system of the invention includes a brake cable control segment extending between the brake lever assembly and the rotatable coupling, and a brake cable operating segment extending between the rotatable coupling and the brake calipers.

According to the improvement of the invention the brake cable control segment is comprised of a single, inextensible upper cable core element forming a single, upper cable core loop having opposing ends. Both of the ends of the upper cable core loop terminate at the rotatable coupling of the cable detangler. A pair of sheath elements surround the portions of the cable core loop residing between the brake lever assembly and the detangler. The cable core element is movable in longitudinally reciprocal fashion through the pair of surrounding sheath elements. However, the cable core loop has opposing sheathed ends with distal, unsheathed terminal extremities, both of which terminate at the rotatable coupling, and also proximal, unsheathed portions residing on opposing sides of the roller. The handlebar-mounted brake lever assembly has a brake lever with a manually actuated lever arm end and an opposing cable-engaging end with a roller secured thereto. The single upper cable core loop is looped about the roller and is movable relative thereto.

The brake lever assembly is provided with a cable segment connector having opposing force application and force transmission ends and a common axis of alignment extending therebetween. The proximate, unsheathed portions of the upper cable core loop extend entirely through the structure of the cable segment connector and the upper cable core loop passes around the roller beyond the force application end of the cable segment connector. A coupler is rotatably located in the cable segment connector so that the coupler and the cable segment connector are freely rotatable relative to each other about the common axis of alignment. The sheath elements are seated in the coupler. The proximate, unsheathed portions of the upper cable core loop are thereby rotatable relative to the cable segment connector, together with the coupler. The upper cable core loop is connected through the roller to the brake lever beyond the force application end of the cable segment connector.

So that it may turn freely, the roller is preferably formed as a pulley having a diameter large enough such that a tangential force applied by the control cable core loop has sufficient leverage to turn the pulley. Also, a connecting link is preferably provided and is rotatably joined to the cable-engaging end of the brake lever. The connecting link carries the pulley or other roller which in turn rotates relative to the connecting link. Together the connecting link and the pulley or other roller mounted thereon accommodate longitudinal shifting of the upper cable core loop relative thereto. As a consequence, the upper cable core loop pulls evenly on both sides of the rotatable portion of the rotatable “detangler” coupling since any inequality in force of application along the length of the upper cable core causes the upper cable core to rotate the pulley or other roller until the forces on the opposing sides of the rotatable coupling are equal. This self-compensation occurs instantly, thereby avoiding cable flop.

The invention may also be considered to be an improvement in a bicycle brake cable system for operating rear wheel brake calipers on a freestyle bicycle having handlebars with a rear brake control lever mounted thereon, a front wheel steering tube, and a front wheel fork mounted for free spinning rotation relative to the bicycle frame head tube. A cable detangler is employed having a nonrotatable collar and a rotatable collar mounted for rotation relative to the nonrotatable collar. The rotatable collar and the nonrotatable collar are both longitudinally reciprocal relative to the head tube.

According to the improvement of the invention a single, inextensible brake control cable core loop is provided. The brake control cable core loop is engaged with the rear wheel brake control lever assembly for movement in reciprocal, traveling relationship thereto.

The brake cable core loop is provided with a pair of surrounding sheath elements within which the cable core loop is movable in longitudinally reciprocal fashion. The brake control cable core loop also has opposing sheathed ends with distal, unsheathed terminal extremities, both of which terminate at the rotatable collar. The rear brake control lever assembly includes a body attached to one of the bicycle handlebars and a brake lever mounted for rotation relative to the body. The brake lever has a manually actuated lever arm end and an opposing, cable-engaging end with a pulley secured thereto. The brake control cable core loop is looped about the pulley and is movable relative thereto. The brake control cable core loop has proximal, unsheathed portions residing on opposing sides of the pulley.

A cable segment connector is engaged in the body of the rear brake control lever assembly. The cable segment connector has opposing force application and force transmission ends and a common axis of alignment extending therebetween. The proximate, unsheathed portions of the cable core loop extend entirely through the structure of the cable segment connector and the brake cable core loop passes around the pulley beyond the force application end of the cable segment connector. A coupler is rotatably located in the force transmission end of the cable segment connector. The coupler is freely rotatable relative to the cable segment connector about the common axis of alignment. The pair of sheath elements are seated in the coupler parallel to the axis of alignment. The proximate, unsheathed portions of the cable core loop are rotatable relative to the cable segment connector, together with the coupler, about the axis of alignment. The cable core loop is connected through the pulley to the cable-engaging end of the manually actuated lever arm beyond the force application end of the cable segment connector.

Preferably also, there is an intermediate link located between the rear wheel brake control lever and the brake control cable core loop. The pulley is mounted on the intermediate link about which the brake control core loop passes in rolling contact therewith. Since the coupler which seats the pair of sheath segments and beyond which the proximal, unsheathed portions of the cable core loop extend is rotatable within the cable segment connector, the proximal, unsheathed portions of the cable core loop are maintained in coplanar relationship with each other, and in coplanar relationship with the pulley despite twisting of the bicycle handlebars. This occurs because the coupler rotates within the cable segment connector to maintain this relationship.

In still another aspect the invention may be considered to be an improvement in a bicycle brake cable system for a rear wheel mounted within a rear wheel fork of a bicycle and in which the bicycle has handlebars, a rear brake lever assembly including a body mounted on the handlebars, and a rear brake control lever joined to the body for rotation relative thereto. The bicycle includes a handlebar mounting stem, a steering tube, and a front wheel fork all mounted for free spinning rotation relative to a bicycle frame head tube. A cable detangler mechanism is employed in such a bicycle brake cable system. The cable detangler mechanism acts between the steering tube and the head tube. A rear brake is mounted on the rear wheel fork to apply braking force against the rear wheel.

According to the improvement of the invention a single, inextensible, brake control cable core is formed into a single cable core loop. A pair of surrounding sheath elements are provided within which the cable core loop is movable in longitudinal reciprocal fashion. The single cable core loop has opposing sheathed ends with distal, unsheathed terminal extremities, both of which terminate at the cable detangler mechanism. The brake control cable core is formed into a single loop that is engaged at a floating contact location relative to the rear brake control lever. The rear brake control lever has a manually actuated lever arm end and an opposing cable-engaging end with a roller secured thereto. The single cable core loop passes about the roller at a floating contact location relative to the rear brake control lever. The brake control cable core also has proximal, unsheathed portions residing on opposing sides of the roller.

A cable segment connector is mounted on the brake lever assembly body. The cable segment connector has opposing force application and force transmissions ends and a common axis of alignment extending therebetween. The proximate, unsheathed portions of the upper cable core element extend through the structure of the cable segment connector. The single cable core loop passes around the roller beyond the force application end of the cable segment connector so that the coupler and the cable segment connector are freely rotatable relative to each other about the common axis of alignment. A pair of sheath elements surround the sheathed ends of the single cable core loop and are seated in the coupler. The proximal unsheathed portions of the cable core element are rotatable relative to the cable segment connector, together with the coupler. The single upper cable core loop is connected through the roller to the rear brake control lever beyond the force application end of the cable segment connector.

Preferably the roller is a pulley that is joined to the brake control lever. The single brake control cable core loop is passed about the pulley which rotates in response to movement of the floating contact location on the loop.

The cable-engaging end of the brake control lever is preferably provided with an intermediate toggle link rotatably joined to the cable-engaging end of the handlebar-mounted brake lever. Opposite the connection between the intermediate toggle link and the cable-engaging end of the brake lever there is a roller in the form of a pulley about which the control cable core passes.

The invention may be described with greater clarity and particularity by reference to the accompanying drawings.

### DESCRIPTION OF THE DRAWINGS

FIG. 1 is a perspective view of a bicycle that incorporates the improved bicycle brake cable system of the invention.

FIG. 2 is a rear elevational, diagrammatic view of the bicycle brake cable system of the invention employed on the bicycle shown in FIG. 1.

FIG. 3 is a rear elevational detail illustrating equalization of force to both ends of the upper rear brake control cable core loop.

### DESCRIPTION OF THE EMBODIMENT

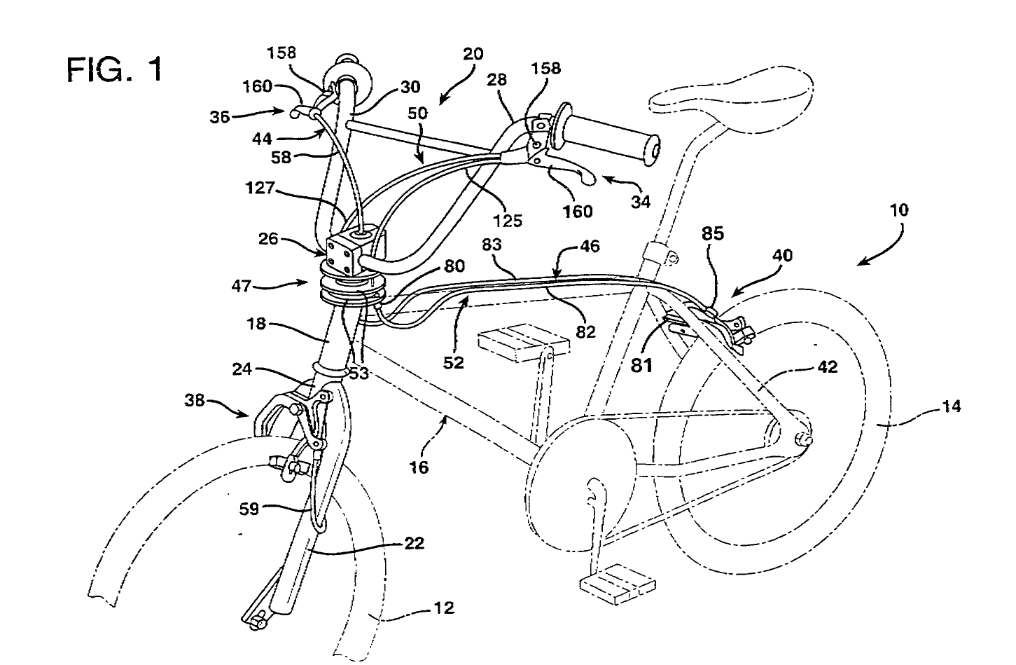

FIG. 1 illustrates a bicycle 10 having the usual front wheel 12 and real wheel 14 which support a rigid, tubular steel or aluminum frame 16. The frame 16 is equipped with a hollow, cylindrical, annular bicycle frame head tube 18 at its forward end and a rear wheel fork 42 at its rear end.

The bicycle 10, like all bicycles, includes a front wheel steering assembly indicated generally at 20. The front wheel steering assembly 20 includes the front wheel 12, a front wheel fork 22, a steering tube 24, a handlebar stem 26, and a set of handlebars 28 and 30. The steering tube 24 is located atop the front wheel fork 22 and projects upwardly through the head tube 18 of the frame 16. The upper portion of the steering tube 24 that protrudes into the head tube 18 is captured within the grip of the stem 26. The stem 26 also carries the handle bars 28 and 30.

A rear wheel brake control 34 and a front wheel brake control 36 are respectively mounted on the handlebars 28 and 30 in the handlebar set. The rear brake control 34 is a rear brake lever assembly equipped with a cable connector assembly 115, which will subsequently be described herein. The bicycle 10 also includes a front wheel brake 38 and a rear wheel brake 40. The front wheel brake 38 is mounted on the front wheel fork 22, while the rear wheel brake 40 is mounted on the rear wheel fork 42. A front brake cable 44 and a rear brake cable 46 lead respectively from the front and rear brake controls 36 and 34 to the front and rear wheel brakes 38 and 40.

A rotatable brake cable coupling system 47 is mounted on the bicycle 10 and is interposed between the head tube 18 and the steering tube 24. The rotatable brake cable coupling system 47 and the front brake cable 44 are illustrated and described in detail in prior U.S. Pat. No. 5,791,671, which is hereby incorporated herein by reference in its entirety. The rotatable brake cable coupling system 47 includes a rotor assembly that divides the rear brake cable 46 into a control segment 50 that is secured to the rear brake control 34 and to the handlebar 28 and an operating segment 52 that is secured to the bicycle frame 16 and to the rear wheel brake 40.

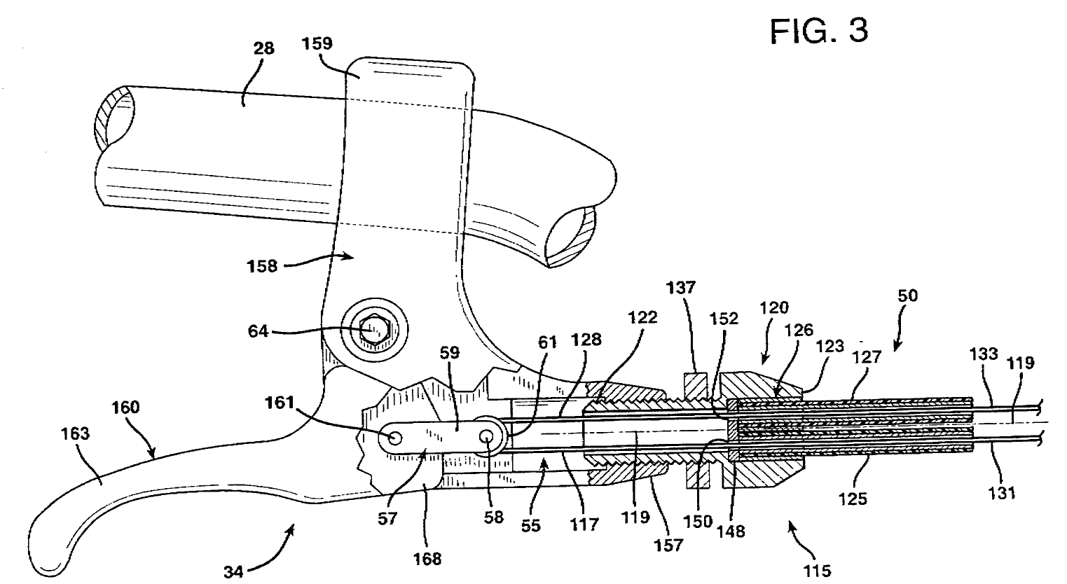

The rear brake operating control 34 is illustrated diagrammatically in detail in FIG. 3. The rear brake operating control 34 includes a conventional bicycle hand brake control lever 160 that is rotatably mounted to a hand brake mounting lever control body 158 that includes a bracket 159 which is secured to the handlebar 28 by conventional means. The handlebar-mounted brake lever 160 is rotatable relative to the brake control body 158 by means of a conventional axle connection at a fulcrum bolt 64. A portion of the mounting lever control body 158 is broken away in FIG. 3 to allow illustration of the operating components of the brake cable control segment 50.

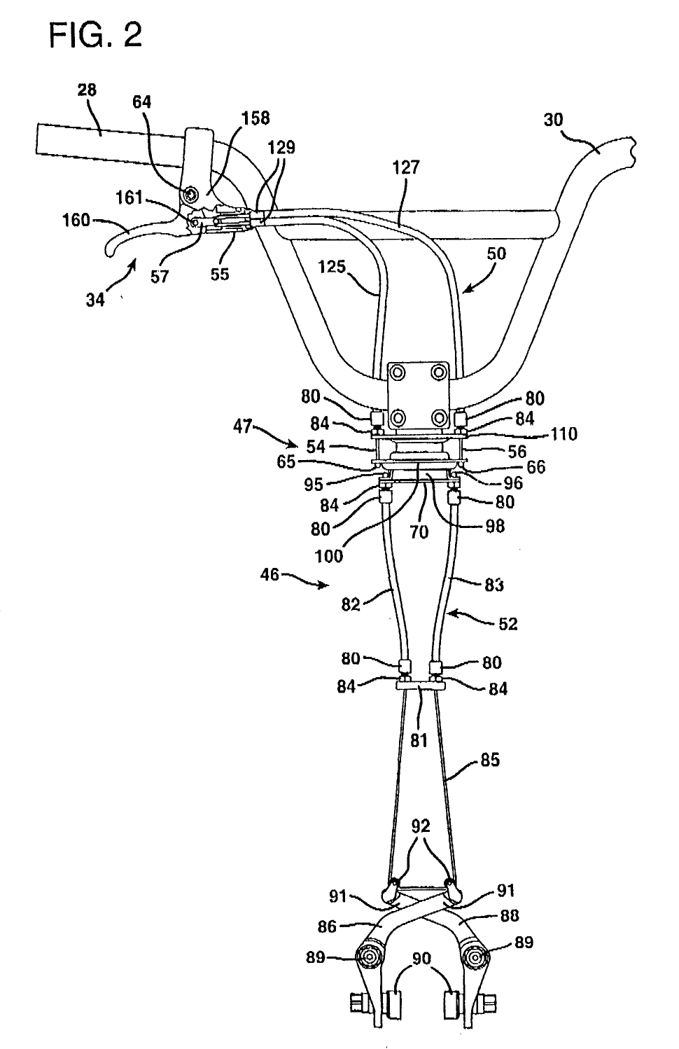

The operating components of the rotatable brake cable coupling system 47 that interact with the components of the rear brake cable 46 are illustrated diagrammatically in FIG. 2. The upper control segment 50 of the rear brake cable 46 is formed of a single, inextensible rear brake control cable core segment formed into a loop 55 that is looped about a pulley 61. The pulley 61 is mounted for rotation on an axle pin 58 that in turn is mounted on an intermediate connecting toggle link 57. The toggle link 57 is formed of a pair of mutually parallel side plates 59 spaced apart a sufficient distance to receive the pulley 61 therebetween. The opposite ends of the toggle link side plates 59 are secured by a hinge pin 161 that forms a rotatable connection with the cable-engaging end 168 of the handlebar-mounted brake lever 160. The opposite, manually actuated lever arm end 163 of the brake lever 160 extends in an outboard direction spaced from and oriented in the same general direction as the outboard end of the bicycle handlebar 28. The manually actuated lever arm end 163 of the brake lever 160 is spaced from the handlebar 28 just a short distance, so that pressure toward the handlebar 28 can be exerted on it by the fingers of the hand of a rider whose palm exerts a force in an opposing direction on the handlebar 28.

The upper control segment 50 of the rear brake cable 46 includes a pair of surrounding sheath elements 125 and 127, formed of tough, stiff plastic, within which the upper cable core loop 55 is movable in longitudinally reciprocal fashion. The cable core loop 55 has proximal, unsheathed portions 117 and 128 and opposing sheathed ends 131 and 133 with distal, unsheathed terminal extremities 54 and 56. Both of the distal, unsheathed terminal extremities 54 and 56 terminate at the rotatable collar 100 at diametrically opposed ears thereon. The proximal, unsheathed portions 117 and 128 of the cable core loop 55 reside on opposing sides of the pulley 61.

A cable segment connector 120 is engaged in the body 158 of the brake lever control assembly 34 at an opposite end 157 thereof from the brake lever 160. The cable segment connector 120 has an externally threaded, barrel-shaped force application 1;0 end 122, an opposing force transmission cable sheath seating end 123, and a common axis of alignment 119 extending therebetween. A coupler 126 is rotatably located in the force transmission end 123 of the cable segment connection 120. The coupler 126 is freely rotatable relative to the cable segment connection 120 about the common axis of alignment 119. The pair of sheath elements 125 and 127 are seated in the coupler 126 parallel to the axis of alignment 119 and equidistant therefrom. The proximate, unsheathed portions 117 and 128 of the upper cable core loop are rotatable relative to the cable segment connector 120, together with the coupler 126. The upper cable core loop 55 is connected through the pulley 61 to the force application lever 160 beyond the force application end 122 of the cable segment connector 120.

The cable segment connector 120 is externally threaded into an internally tapped opening in the end 157 of the brake lever assembly body 158 remote from the brake lever 160. A locking nut 137 is externally engaged on the threads of the force application end 122 of the cable segment connector 120. The locking nut 137 may be unscrewed away from the end 157 of the body 158 to permit rotation of the cable segment connector 120 relative to the brake lever assembly body 158, as illustrated in FIG. 3. By threadably advancing the clamping nut 137 toward the brake lever assembly body 158, the cable segment connector 120 may be immobilized relative to the brake lever assembly body 158. When the locking nut 137 is loosened, the cable segment connector 120 may be advanced in either direction by screwing or unscrewing the threaded force application end 122 thereof relative to the internally threaded barrel end 157 of the brake lever assembly body 158.

The pulley 61 is located externally of the cable segment connector 120 proximate to and beyond the force application end 122 thereof. The proximal, unsheathed portions 117 and 128 of the inextensible core loop 55 pass through the structure of the cable segment connector 120 and beyond, into the cable passageway defined in the body 158 of the brake lever assembly 34. The proximal ends of the sheath elements 125 and 127 have an outer diameter that fits snugly within dual, mutually parallel passageways through the coupler 126. These passageways are spaced equidistant from the longitudinal axis of alignment 119 and are separated from each other by a distance approximately equal to the diameter of the pulley 61.

A metal, annular thrust washer 148 is interposed between the coupler 126 and a transverse, annular bearing ledge within the cable segment connector 120 facing the force transmission end 123. The thrust washer 148 has an outer diameter that extends nearly to the wall of the cylindrical cavity at the exposed force transmission end 123 of the cable segment connector 120, and a pair of apertures 150 and 152, spaced equidistant from the longitudinal axis 119 and aligned with the proximal, unsheathed portions 117 and 128 of the upper control cable core loop 55. The unsheathed portions 117 and 128 thereby pass through the apertures 150 and 152 in the thrust washer 148, but the proximal ends of the cable sheath elements 125 and 127 are stopped in abutment against the thrust washer 148.

When a longitudinal, tensile force is applied to the brake lever arm end 163 of the brake lever 160, the coupler 126 bears against the bearing ledge within the cable segment connector 120, but is freely rotatable within the cylindrical cavity defined at the force transmission end 123 of the cable segment connector 120. This rotation is facilitated by the presence of the thrust washer 148.

The cable connector assembly 115, including the cable segment connector 120, the coupler 126, and the thrust washer 148 are substantially identical to the system described in prior U.S. Pat. No. 6,085,611, issued Jul. 21, 2000 and U.S. Pat. No. 6,199,455, issued Mar. 13, 2001, both of which are hereby incorporated by reference in their entireties.

As the cable-engaging lever arm end 163 of the brake lever 160 is drawn closer to the handlebar 28, tension is exerted on the single upper cable core loop 55 to draw the lower extremities 54 and 56 of the upper control cable core loop 55 upwardly, as viewed in FIG. 2, and to draw the proximal, unsheathed sections 117 and 128 of the upper cable core loop 55 longitudinally beyond the cable segment connector 120 and further into the hand brake assembly body 158.

As illustrated in FIG. 1, the front brake cable 44 includes an upper, plastic, tubular sheathed section 58 and a lower, plastic, tubular sheathed section 59 that are disposed coaxially about a front wheel brake cable core formed of an inextensible material, such as a plurality of twisted stainless steel wires. At least the core of the front brake cable 44 is routed through a longitudinal passageway formed through the hollow, threadless steering tube 24 and extends from the front brake control 36 to the front wheel brake 38.

The handlebars 28 and 30, the front wheel mounting stem 24, and the front wheel fork 22 are all mounted together for free spinning rotation relative to the bicycle frame head tube 18 and relative to the bicycle frame 16. With the routing of the front brake cable 44 and the provision of a rotatable brake cable coupling system 47, the steering assembly 20, the rear brake cable control segment 50, and the front brake cable 44 are freely rotatable together relative to the head tube 18 and relative to the rear brake cable operating segment 52.

As shown diagrammatically in FIG. 2, a pair of diametrically opposed, lower, nonrotatable brake cable termination ears project radially outwardly from a lower cable stop plate 70 that resides in abutment against the upper edge of the bicycle frame head tube 18. The lower cable stop plate 70 is held immobilized relative to the head tube 18. The ears that project outwardly from the lower cable stop plate 70 have longitudinal, internally threaded openings defined therethrough.

The rotatable brake cable coupling system 47 is a cable detangler that has both a nonrotatable rotationally immobilized connection collar 98 and a collar 100 mounted for free rotation relative to the nonrotatable collar 98. The nonrotatable collar 98 is formed as an annular structure that has an inner periphery that extends from beneath the rotatable collar 100 upwardly through a central axial opening in the rotatable collar 100 to form an upper rotor bearing race, as described in U.S. Pat. No. 5,791,671. The upper extremity of the inner periphery of the nonrotatable collar 98 is turned radially outwardly to overhang the radially inner portion of the structure of the rotatable collar 100.

The rotatable brake cable coupling system 47 is provided with a thrust washer atop which an upper cable stop 110 is seated. The upper cable stop 110 is provided with a pair of diametrically opposed, radially projecting ears through which internally tapped openings are formed. The upper control cable sheath sections 125 and 127 are formed of stiff, but bendable plastic. The upper ends of the plastic cable sheath sections 125 and 127 are secured to the brake control body 158 by the cable connector assembly 115. The lower ends of the cable sheath sections 125 and 127 terminate in coupling end terminations that have nipples engaged in the threaded apertures of the ears of the upper cable stop 110. The unsheathed end extremities 54 and 56 of the rear cable control core 55 extend downwardly past the cable sheath sections 125 and 127 and through the ears of the cable stop 110 and are secured by means of knobs 65 and 66 on diametrically opposed sides of the rotatable collar 100 of the rotatable brake cable coupling system 47.

The lower rear cable operating segment 52 of the brake cable system of the invention is preferably formed with a pair of hollow, plastic operating segment cable sheath sections 82 and 83. The operating segment cable sheath sections 82 and 83 are formed of a stiff, but bendable plastic. The cable sheath sections 82 and 83 are secured to the bicycle frame 16 periodically at intervals between the rotatable brake cable coupling system 47 and the rear wheel bicycle brake fork 42 so that very little lateral flexure of the operating segment brake cable sheath sections 82 and 83 can occur. The cable sheath sections 82 and 83 both have upper, forward ends that terminate at a pair of control coupling end terminations 80 on diametrically opposite sides of the lower cable stop plate 70. The stop plate 70 has a pair of ears that project diametrically outwardly with longitudinally, internally threaded openings defined therethrough. The control coupling end terminations 80 both have upwardly directed nipples that are threaded into the openings in the stop plate 70. Adjusting nuts 84 are threadably engaged externally upon the threaded nipples at the control coupling end terminations 80 and bear against the underside of the stop plate 70.

The lower, rear ends of the operating segment cable sheath sections 82 and 83 likewise terminate in coupling end terminations 80 that are secured to a stop bar 81 that is anchored to the bicycle frame 16 proximate the rear wheel bicycle fork 42 just forward of the rear brake 40. The end coupling terminations 80 at the rear ends of the cable sheath sections 82 and 83 are threadably engaged in the stop bar 81 with adjusting nuts 84 in the same manner as previously described with respect to the upper, forward ends of the operating segment cable sheath sections 82 and 83.

The bicycle brake cable system of the invention preferably utilizes a single, inextensible rear brake cable core loop 85. In the embodiment shown the loop 85 has opposing ends that extend forward to the head tube 18 and terminate in lower segment coupling end termination knobs 95 and 96. The cable sheath sections 82 and 83 are disposed about the portions of the two ends of the rear cable core loop 85 that extend between the rear stop bar 81 and the lower stop plate 70. Both of the end extremities of the single cable core loop 85 are joined by the knobs 95 and 96 to the nonrotatable collar 98.

The rear brake 40 is comprised of a pair of brake calipers 86 and 88. Both of the brake calipers 86 and 88 are hinged for rotation about brake caliper mounting posts 89 that are anchored on opposing sides of the rear bicycle wheel fork 42. Each of the brake calipers has a brake pad end upon which a brake pad 90 is mounted and an opposing cable-engaging lever arm end 91 at which a roller in the form of a pulley 92 is mounted. The single lower cable core loop 85 is looped about both the cable-engaging lever arm ends 91, since it is looped over both of the pulleys 92.

The rear brake 40 operates in the following manner. When the brake lever 160 is squeezed toward the handlebar 28 and rotates relative to the stationary brake control lever body member 158, tension is exerted on the single, cable core loop 55 in the upper, control segment 50 of the rear brake cable 46 through the toggle link 57.

Tension is ideally exerted equally on both of the cable core ends 54 and 56, thereby drawing the rotatable plate 100 of the detangler or rotatable brake cable coupling system 47 upwardly, longitudinally relative to the bicycle frame head tube 18.

The upward movement of the rotatable plate 100 likewise pulls the nonrotatable plate 98 upwardly, thereby pulling the single cable core loop 85 of the operating segment 52 of the rear brake cable 46 away from the rear bicycle wheel 14. The tension on the ends of the rear brake cable core loop 85 that terminate in the knobs 95 and 96 is transmitted to the lever arm ends 91 of the pair of cooperating brake calipers 86 and 88.

This force pulls the lever arm ends 91 of the brake calipers 86 and 88 toward each other, thereby rotating the brake calipers 86 and 88 and bringing the brake pads 90 to bear against the sides of the rear wheel 14 located therebetween.

If the rear brake 40 is perfectly adjusted, and if the end coupling terminations 80 and the adjusting nuts 84 are likewise perfectly adjusted, the cable detangler mechanism 47 will remain in perfect perpendicular alignment relative to the bicycle head tube 18.

More typically, however, there will be some slight variation in force applied to the cable core ends 54 and 56 of the upper brake control cable segment 50. In a conventional bicycle brake cable coupling system for the rear wheel of the bicycle 10 employing a detangler mechanism 47, this inequality in force will result in tilting or “flop” of the cable detangler 47, causing it to move out of perpendicular alignment relative to the head tube 18. However, by employing the single cable core loop 55 in the rear brake cable control segment 50 in such a manner that the cable loop 55 is movable relative to the cable-engaging end 168 of the brake lever 160, there is an automatic compensation for any force inequality.

For example, braking force is applied to the rear brake 40, shown in FIGS. 1 and 2, by rotation of the brake lever 160 in a clockwise direction about the axle pin 64, as viewed in FIG. 3. That is, the rider squeezes the manually actuated lever arm end 163 of the brake lever 160 in a clockwise direction toward the handlebar 28. This force pulls the cable-engaging end 168 of the brake lever 160 to the left, as viewed in FIG. 3. This force acts through the toggle link 57 to pull the axle pin 58 of the pulley 61 to the left as well.

If the resistance on the end 54 of the upper cable core loop 55 is initially greater than the resistance on the end 56 of the cable core loop 55, the pulley 61 will rotate in a counterclockwise direction about the axle pin 58 so that a portion of the cable core loop 55 travels with it. A portion of the control cable core end 56 is thereby fed onto the pulley 61 and drawn off of the pulley 61 toward the other end 54 of the cable loop 55. As a consequence, the end 56 of the cable loop 55 is thereby shortened, creating a greater force along the end of the cable core loop 55 within the cable sheath section 127. The forces on the diametrically opposed sides of the rotatable collar 100 of the rotatable brake cable coupling system 47 are thereby equalized. The rotatable collar 100 thereby remains in an orientation perpendicular to the head tube 18 as it is drawn longitudinally upwardly relative thereto, carrying with it the nonrotatable collar 98.

Conversely, if the initial resistance on the end 56 of the brake cable core loop 55 is initially greater than the resistance on the end 54, the opposite will occur. That is, with a clockwise force applied to the manually actuated lever arm end 163 of the brake lever 160 as viewed in FIG. 3, the greater resistance at the cable core end 56 will cause the pulley 61 to rotate in a clockwise direction, thereby shortening the end 54 and lengthening the end 56 of the upper cable core control loop 55. The forces on the ends 54 and 56 are thereupon again equalized, thus holding both the rotatable collar 100 and the nonrotatable collar 98 in perpendicular orientation relative to the head tube 18. As a consequence, the “gyro” or cable detangler mechanism 47 is always in held in a perpendicular orientation relative to the bicycle head tube 18, thereby avoiding cable “flop”.

As tension is exerted on the upper cable core control loop 55, quite often there are torsional forces that act upon the proximal, unsheathed portions 117 and 128 of the cable core loop 55 tending to twist these portions of the cable core loop 55 out of coplanar alignment with the pulley 61. However, since the coupler 126 is freely rotatable within the cylindrical cavity defined at the force transmission end 123 of the cable segment connector 120, these torsional forces are neutralized by rotation of the coupler 126 within the cable segment connector 120. As a consequence, the pulley 61 is able to rotate freely in response to the passage of the cable core loop 55 across it. The pulley 61 thereby does not bind. This aids significantly in eliminating “flop” of the cable detangler 47.

It is to be understood that the self-balancing feature of the bicycle brake system of the invention occurs whatever the reason for an imbalance of forces along the length of the cable loop 55 of the rear brake cable control segment 50. Such force imbalances can result from a difference in distance of the brake pads 90 from the wheel rim of the rear wheel 14, and also from minor misadjustments of the adjusting nuts 84, flexure in the cable sheaths 125,127 and 82,83, and other imbalancing forces. In all such situations the floating force application locations along the single cable loop 55 of the brake cable control segment 50 passing over the pulley 61 equalizes the opposing forces on the opposite sides of the detangler mechanism 47. The equalization of these forces keeps the “gyro” or detangler mechanism 47 from tilting or “flopping” relative to the head tube 18.

Undoubtedly, numerous variations and modifications of the invention will become readily apparent to those familiar with bicycle brake cable system. For example, while the use of a pulley at the cable-engaging end 168 of the brake lever 160 is preferred, the cable loop 55 could be looped through a fixed, nonrotatable guide. In such a situation the cable would merely slide around the guide in making a one hundred eighty degree turn. Also, a simple roller could be substituted for the pulley 61. However, the use of a pulley or sheave is preferred to avoid any friction between the cable loop 55 and the side plates 59 of the toggle link 57.

The connecting link or toggle link 57 aids in maintaining equal forces on the ends 54 and 56 of the cable loop 55. Without the toggle link 57 there would be a greater tendency for more force to be applied to the cable loop end 54 furthest from the axis of rotation of the brake lever 160, as contrasted with the force applied to the cable loop end 56 nearest to the fulcrum bolt 64. However, due to the self-adjusting nature of the brake cable control segment 50, the cable loop ends 54 and 56 would still be alternatively shortened or lengthened in the manner previously described.

Also, various types of “gyro” or cable detangler systems may be utilized in place of the rotatable coupling 47, illustrated and described. Accordingly, the scope of the invention should not be construed as limited to the specific embodiment depicted and described herein, but rather is defined in the claims appended hereto.

I claim:

1. A bicycle brake cable system for operating a pair of opposing bicycle brake calipers from a handlebar-mounted brake lever assembly and including, a rotatable coupling enabling free spinning of a bicycle handlebar and front wheel assembly relative to an associated bicycle frame and further including a brake cable control segment extending between said brake lever assembly and said rotatable coupling, and a brake cable operating segment extending between said rotatable coupling and said brake calipers, the improvement wherein said brake cable control segment is comprised of a single, inextensible, upper core element forming a single, upper cable core loop and a pair of surrounding sheath elements within which said upper cable core element is movable in longitudinally reciprocal fashion, and said upper cable core loop has opposing sheathed ends with distal, unsheathed terminal extremities, both of which terminate at said rotatable coupling, and said handlebar-mounted brake lever assembly includes a body attached to a bicycle handlebar and a brake lever mounted for rotation relative to said body, and said brake lever has a manually actuated lever arm end and an opposing cable-engaging end with a roller secured thereto, and said single upper cable core loop is looped about said roller and is movable relative thereto, and has proximal, unsheathed portions residing on opposing sides of said roller, and further comprising a cable segment connector having opposing force application and force transmission ends and a common axis of alignment extending therebetween, and wherein said proximate, unsheathed portions of said upper cable core element extend entirely through the structure of said cable segment connector and said upper cable core loop passes around said roller beyond said force application end of said cable segment connector, and further comprising a coupler rotatably located 25′ in said cable segment connector so that said coupler and said cable segment connector are freely rotatable relative to each other about said common axis of alignment and said sheath elements are seated in said coupler, and said proximate, unsheathed portions of said upper cable core element are rotatable relative to said cable segment connector together with said coupler and said upper cable core loop is connected through said roller to said brake lever beyond said force application end of said cable segment connector.

2. A bicycle brake cable system according to claim 1 further comprising a connecting link rotatably joined to said cable-engaging end of said brake lever and carrying said roller, whereby said roller rotates relative to said connecting link to accommodate longitudinal shifting of said upper cable core loop relative thereto, and said brake lever moves in rotation relative to said connecting link.

3. A bicycle brake cable system according to claim 1 wherein said roller is a pulley whereby uneven resistance on said opposing upper cable core ends causes said pulley to rotate relative to said brake lever to equalize force transmitted to said distal, unsheathed terminal extremities of said upper cable core loop by said rotatable coupling.

4. In a bicycle brake cable system for operating rear wheel brake calipers on a freestyle bicycle having handlebars with a rear brake control lever assembly mounted thereon, a front wheel steering tube and a front wheel fork mounted together for free spinning rotation relative to a bicycle frame head tube, and including a cable detangler having a nonrotatable collar and a rotatable collar mounted for rotation relative to said nonrotatable collar, and wherein said rotatable collar and said nonrotatable collar are longitudinally reciprocal relative to said head tube, the improvement comprising a single, inextensible brake control cable core loop and said brake control cable core loop is engaged with said rear wheel brake control lever assembly for movement in reciprocal, traveling relationship relative thereto, and further comprising a pair of surrounding sheath elements within which said upper cable core loop is movable in longitudinally reciprocal fashion, and said brake control cable core loop also has opposing sheathed ends with distal, unsheathed terminal extremities, both of which terminate at said rotatable collar, and said rear brake control lever assembly includes a body attached to one of said bicycle handlebars and a brake lever mounted for rotation relative to said body, and said brake lever has a manually actuated lever arm end and an opposing cable-engaging end with a pulley secured thereto, and said brake control cable core loop is looped about said pulley and is movable relative thereto, and has proximal, unsheathed portions residing on opposing sides of said pulley, and further comprising a cable segment connector engaged in said body of said rear brake control lever assembly, wherein said cable segment connector has opposing force application and force transmission ends and a common axis of alignment extending therebetween, and wherein said proximate, unsheathed portions of said cable core loop extend entirely through the structure of said cable segment connector and said brake control cable core loop passes around said pulley beyond said force application end of said cable segment connector, and further comprising a coupler rotatably located in said force transmission end of said cable segment connector so that said coupler is freely rotatable relative to said cable segment connector about said common axis of alignment and said pair of sheath elements are seated in said coupler, and said proximate, unsheathed portions of said upper cable core loop are rotatable relative to said cable segment connector, together with said coupler about said axis of alignment, and said brake control cable core loop is connected through said pulley to said cable-engaging end of said manually actuated lever arm beyond said force application end of said cable segment connector.

5. A bicycle brake cable system according to claim 4 further characterized in that said coupler rotates within said cable segment connector to maintain said proximal unsheathed portions of said brake control cable core loop in coplanar relationship with said pulley, and said brake control cable core loop passes about said pulley in running engagement therewith.

6. A bicycle brake cable system according to claim 4 further comprising an intermediate link located between said brake lever and said brake control cable core loop, and said pulley is mounted on said intermediate link and said brake control cable core loop passes about said pulley in rolling contact therewith.

7. A bicycle brake cable system according to claim 4 further comprising a link rotatably joined to said brake lever, and a pulley mounted on said link, and engaged by said brake control cable core loop.

8. In a bicycle brake cable system for a rear wheel mounted within a rear wheel fork of a bicycle in which said bicycle has handlebars, a rear brake lever assembly including a body mounted on said handlebars, and a rear brake control lever joined to said body for rotation relative thereto, a handlebar mounting stem, a steering tube, and a front wheel fork all mounted for free spinning rotation relative to a bicycle frame head tube, and employing a cable detangler mechanism between said steering tube and said head tube, and a rear brake mounted on said rear wheel fork to apply braking force against said rear wheel, the improvement comprising a single, inextensible, brake control cable core formed into a single cable core loop and a pair of surrounding sheath elements within which said brake control cable core is movable in longitudinally reciprocal fashion, and said single cable core loop has opposing sheathed ends with distal, unsheathed terminal extremities, both of which terminate at said cable detangler mechanism, and said rear brake control lever has a manually actuated lever arm end and an opposing cable-engaging end with a roller secured thereto, and said single cable core loop passes about said roller and is movable relative thereto at a floating contact location relative to said rear brake control lever, and said brake control cable core has proximal, unsheathed portions residing on opposing sides of said roller, and further comprising a cable segment connector mounted on said brake lever assembly body and having opposing force application and force transmission ends and a common axis of alignment extending therebetween, and wherein said proximate, unsheathed portions of said brake control cable core extend through the structure of said cable segment connector and said single cable core loop passes around said roller beyond said force application end of said cable segment connector, and further comprising a coupler rotatably located in said cable segment connector so that said coupler and said cable segment connector are freely rotatable relative to each other about said common axis of alignment, and a pair of sheath elements surround said sheathed ends of said single cable core loop and are seated in said coupler, and said proximate, unsheathed portions of said cable core element are rotatable relative to said cable segment connector, together with said coupler, and said single cable core loop is connected through said roller to said rear brake control lever beyond said force application end of said cable segment connector.

9. A bicycle brake cable system according to claim 8 further wherein said roller is a pulley joined to said rear brake control lever, and said single brake control cable core loop is passed about said pulley which rotates in response to movement of said floating contact location on said loop.

10. A bicycle brake cable system according to claim 9 further comprising a toggle link carrying said pulley and interposed between said single cable core loop and said rear brake control lever.
